(19) United States
(12) Patent Application Publication
(10) Pub. No.: US 2012/0009542 A1
(43) Pub. Date: Jan. 12, 2012

(54) APPARATUS, SYSTEM, AND METHOD FOR REMOVAL OF DENTAL PROSTHESIS

(76) Inventors: James Keddington, Bountiful, UT (US); Paul Ericksen, Bountiful, UT (US)

(21) Appl. No.: 13/181,164

(22) Filed: Jul. 12, 2011

Related U.S. Application Data
(60) Provisional application No. 61/363,505, filed on Jul. 12, 2010.

(51) Int. Cl. A61C 3/00

(52) U.S. Cl. 433/75

(57) ABSTRACT

An apparatus, system, and method are disclosed for facilitating removal of a dental prosthesis. A recess on a dental prosthesis is included and the dental prosthesis is mountable on one or more dental studs. The one or more dental studs are each connected to a dental implant in the jaw of a user. The recess includes a tool engaging surface, and the tool engaging surface has a shape corresponding to a recess engaging surface of a removal tool. The user may apply the recess engaging surface of the removal tool to the tool engaging surface of the recess and apply a force in a direction to remove the dental prosthesis from the one or more dental studs.

### CROSS-REFERENCES TO RELATED APPLICATIONS

This application claims the benefit of U.S. Provisional Patent Application No. 61/363,505 entitled “Apparatus, System, and Method for Removal of Dental Prosthesis” and filed on Jul. 12, 2010 for James Keddington, et al., which is incorporated herein by reference.

### FIELD OF THE INVENTION

This invention relates to dental prostheses and more particularly relates to the removal of dental prostheses mounted on dental implants.

### BACKGROUND

Modern dental prostheses, such as dentures, bridges, and crowns, provide significant cosmetic, health, and functional benefits to those who may otherwise suffer from missing one or more teeth. Increased benefits are provided through the use of dental implants which allow dental prostheses to be used similar to natural, healthy teeth due to their stability in the jaw. Dental prostheses mounted on dental implants may be used for chewing and eating foods that may otherwise be difficult or impossible for a patient to eat.

In order to provide many of the above benefits, dental prostheses are mounted to dental implants in a manner that can require significant force to remove the dentures. Because dentures are designed to look like natural, healthy teeth and gums, they are often smooth and/or slippery making them difficult to grasp. Many patients using dental implants must use their fingernails on the upper edge of the implants to get any grip at all. This method is often still inadequate if patients have long or short fingernails, or especially if a patient has reduced hand dexterity and/or strength. Additionally, the use of fingernails or a tool on the upper edge can sometimes result in the gouging of a patient's natural gums causing pain, bleeding, or other oral damage.

### SUMMARY

From the foregoing discussion, it should be apparent that a need exists for an apparatus, system, and method that simplify removing a dental prosthesis. Beneficially, such an apparatus, system, and method would allow a user to apply a removal tool to a recess in the dental prosthesis for removal.

The present invention has been developed in response to the present state of the art, and in particular, in response to the problems and needs in the art that have not yet been fully solved by currently available methods for removing dentures, partial dentures, etc. Accordingly, the present invention has been developed to provide an apparatus, system, and method for facilitating removal of a dental prosthesis that overcome many or all of the above-discussed shortcomings in the art.

The apparatus, in one embodiment, includes a recess on a dental prosthesis, where the dental prosthesis is mountable on one or more dental studs. The one or more dental studs are each connected to a dental implant in the jaw of a user. The recess includes a tool engaging surface. The tool engaging surface, in one embodiment, has a shape corresponding to a recess engaging surface of a removal tool. The user may apply the recess engaging surface of the removal tool to the tool engaging surface of the recess and apply a force in a direction to remove the dental prosthesis from the one or more dental studs.

In one embodiment, the tool engaging surface has a shape that closely matches the recess engaging surface of the removal tool. In another embodiment, the recess includes an indentation with a shape that is a shelf and/or a pocket. In another embodiment, the dental prosthesis includes upper dentures, and the recess is located below an upper edge of the dental prosthesis. In another embodiment, the dental prosthesis includes lower dentures, and the recess is located above a lower edge of the dental prosthesis.

In one embodiment, the recess is located on a gum portion of the dental prosthesis. In a further embodiment, the recess is located above a gum line of the dental prosthesis and below a top edge of the dental prosthesis, where the top edge is distal to false teeth connected to the gum portion. In another further embodiment, the recess is located near the top edge of the gum portion dental prosthesis such that the recess fits within the gum portion and a top portion of the recess is adjacent to the top edge.

In one example, the tool engaging surface of the recess includes a seat portion, where the seat portion includes a substantially flat seat portion. In another example, the seat portion includes a ridge above a lower portion. The ridge is positioned near the external surface of the dental prosthesis and the lower portion is positioned adjacent to the ridge and toward an interior of the dental prosthesis.

In one embodiment, the recess and the dental prosthesis are formed of different materials. In a further embodiment, the dental prosthesis is at least partially formed from a first material and the recess is at least partially formed of a second material, where the second material is stronger than the first material. In various embodiments, the recess is formed of one or more materials from the group consisting of metal, plastic, acrylic, and porcelain.

In one embodiment, the tool engaging surface includes a retaining ridge configured to allow an engaged removal tool to snap into the recess and to retain the removal tool when a force is applied to the removal tool in a removal direction below a threshold. In a further embodiment, the retaining ridge is positioned perpendicular to the force in the direction to remove the dental prosthesis from the one or more dental studs.

The apparatus, in one embodiment, includes one or more additional recesses on the dental prosthesis. In various embodiments, the dental prosthesis includes one or more anchor housings arranged to connect to the one or more dental studs in the jaw of the user and are arranged to form one or more axes of symmetry, and at least one recess is located on the one or more axes of symmetry. In another embodiment, the recess is located substantially halfway along the length of the dental prosthesis or the width of the dental prosthesis.

In one example, each dental stud of the one or more dental studs corresponds to an anchor housing in the dental prosthesis and a specific amount of force is required to dislodge an anchor housing from a dental stud. In a further embodiment, the force to dislodge the anchor housing from the dental stud is in a direction substantially along an axis aligned with the dental implant connected to the dental stud.

A system of the present invention is also presented to facilitate removal of a dental prosthesis. The system may be embodied by a dental prosthesis, a removal tool, and a recess. In particular, the system, in one embodiment, includes a dental prosthesis mountable on one or more dental studs, where the one or more dental studs are each connected to a dental implant in the jaw of a user. The recess, in one embodiment, is on the dental prosthesis, and the recess includes a tool engaging surface. The tool engaging surface has, in one embodiment, a shape corresponding to a recess engaging surface of the removal tool. In one embodiment, the user may apply the recess engaging surface of the removal tool to a tool engaging surface of the recess and apply a force in a direction to remove the dental prosthesis from the one or more dental studs.

A method of the present invention is also presented for facilitating removal of a dental prosthesis. The method in the disclosed embodiments substantially includes the steps necessary to carry out the functions presented above with respect to the operation of the described apparatus and system. In one embodiment, the method includes creating a recess on a dental prosthesis, where the dental prosthesis is mountable on one or more dental studs. The one or more dental studs are each connected to a dental implant in the jaw of a user. The recess includes a tool engaging surface, where the tool engaging surface has a shape corresponding to a recess engaging surface of a removal tool.

The method also may include engaging the recess engaging surface of the removal tool to the tool engaging surface of the recess. The method may also include applying a force with the recess engaging surface of the removal tool to the tool engaging surface of the recess in a direction to remove the dental prosthesis from the one or more dental studs.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of a dental prosthesis having a recess in accordance with the present invention;

FIG. 2 shows exemplary cutaway views illustrating the configuration of the recess of FIG. 1 in accordance with the present invention;

FIG. 3A shows exemplary seat portions of a recess in accordance with the present invention;

FIG. 3B shows exemplary recess engaging portions of a tool that correspond, in various embodiments, to the seat portions and recesses of FIGS. 2 and 3A in accordance with the present invention;

FIG. 4 shows exemplary embodiments of tools for engaging a recess for removal of a dental prosthesis in accordance with the present invention;

FIGS. 5A-5C show an exemplary method for removing a dental prosthesis in accordance with the present invention;

FIGS. 6A-6C depict various views of one embodiment of a recess housing in accordance with the present invention;

FIGS. 7A-7C depict various views of another embodiment of a recess housing in accordance with the present invention;

FIG. 8 is a top plan view of dentures illustrating the placement of recesses in accordance with the present invention;

FIG. 9 is a plan view of partial dentures illustrating the placement of recesses in accordance with the present invention; and

FIG. 10 is a flowchart diagram of one embodiment of a method for facilitating removal of a dental prosthesis.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

From the foregoing discussion, it should be apparent that a need exists for an apparatus, system, and method that allow for easy and safe removal of dental prostheses mounted on dental implants. To fill this need, the present disclosure describes a recess in a strategic location on the outside of a denture or other dental prostheses. The recess may take many forms and may be a small metal pocket attached to the dentures, a cavity in the dentures, a hole in the dentures, a ledge on the dentures, etc. The recess may then be accessed by a tool that hooks onto the recess. The tool may look somewhat similar to a knitting needle where there is a rod or shaft with a hook at the end. The person pulls on the tool as it engages the recess which puts pressure on the dentures to pull the dentures loose from the dental implants. Exemplary embodiments of the dental prostheses, removal tools, and recesses as wdll as their use will be discussed in relation accompanying figures.

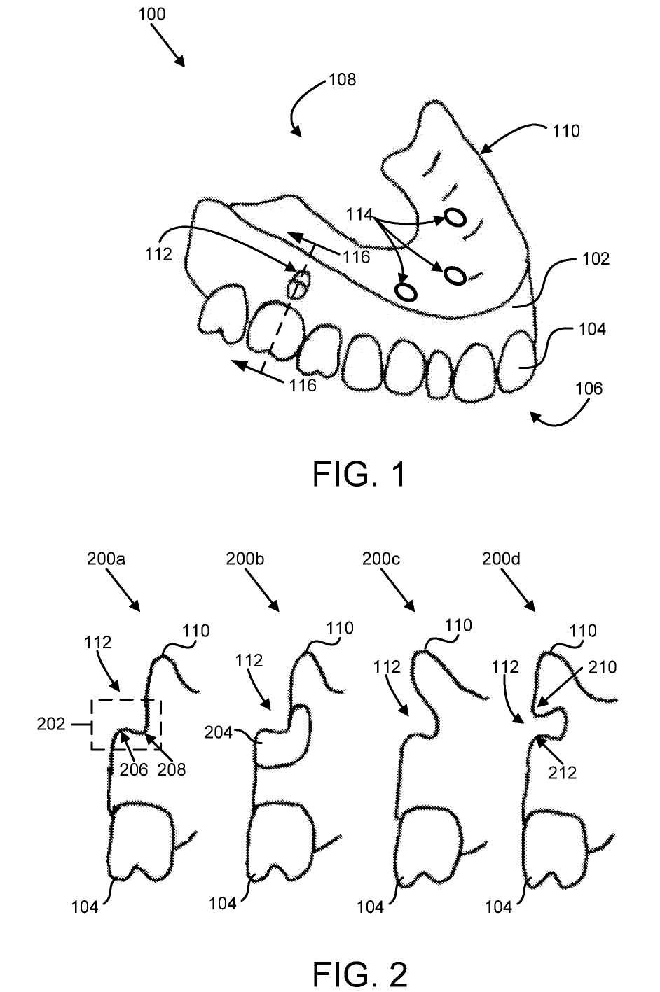

FIG. 1 depicts upper jaw dentures 100 (or “dental prosthesis 100”) according to one embodiment of the present invention. Note that a dental prosthesis 100 include dentures, partial dentures, and other devices worn in the mouth and dental prosthesis, dentures, etc. are used interchangeably herein. The dentures 100 typically include a base 102 and a plurality of teeth 104. The base 102 is the portion of the denture 100 which rests against tissue and/or bone of the upper jaw and in which teeth 104 are set. The base 102 may formed of one or more of a variety of materials well known in the art. Often, the base 102 is formed to look similar to natural and healthy gums. Similarly, the teeth 104 are often formed to look like natural and healthy teeth. For example, the teeth 104 and gums may look similar to natural teeth and gums when the dentures 100 are worn. When mounted in a user's mouth the front end 106 of the dentures 100 is oriented towards user's lips and the back end 108 is oriented towards the throat. As it is often desired by user's that it not be apparent that dentures 100 are being worn, great skill and effort may go into making them look realistic.

The depicted dentures 100 (or dental prosthesis) also include a number of anchor housings 114 for mounting the dentures 100 to dental implants (not shown) within a user's mouth. Dental implants are essentially false tooth roots that are placed in the bone of a patient's jaw. Dental implants often include posts, often called dental studs, which protrude from the false tooth roots. As used herein, a dental stud is a device that mates to a stud housing in a dental prostheses. The dental stud may be part of or connected to a dental implant. A dental implant, as used herein, is a device mounted in the jaw of a patient (“user”) to connect to a dental prosthesis 100. A dental implant may include an implant located in a place of a missing tooth, an implant anchored to or through an existing tooth, an implant located in a jaw of a patient in a location other than the location of a tooth, or any other device used to connect to a dental prosthesis 100.

Dental studs are provided by a number of manufacturers. In one embodiment, the dental stud is a ZEST ANCHOR® by Zest Anchors, LLC located in Escondido, Calif. In another embodiment, the dental stud is a PRECI CLIX™ from Ceka located in Belgium. In another embodiment, the dental stud is part of the OSO™ O-ring component system from the Preat Corporation of Santa Ynez, Calif. Dental studs may be part of a dental implant or may be inserted, screwed, attached, etc. to a dental implant. One or skill in the art will recognize other dental studs and dental stud providers. According to the depicted embodiment, the anchor housings 114 are designed to receive and attach to the dental studs (not shown) to secure the dentures 100 in place in the user's mouth.

Due to the possibility of eating sticky or hard foods, the connection between the dental studs and the anchor housings 114 is often designed to be quite strong. In some embodiments, it may take a significant amount of force to release the connection between the anchor housings 114 and dental studs. According to one embodiment, 20 pounds of force may be required. A larger or smaller amount of force may be required in various embodiments. In some embodiments, an o-ring or other attachment may be mated with a dental stud to change an amount of force required to separate an anchor housing 114 of a dental prosthesis 100 from a dental implant.

The strong connection between the anchor housings 114 and dental studs may often make it difficult for user's to remove their dentures 100 by hand. This difficulty is often magnified by the smoothness, shape, and/or slipperiness of the dentures 100. Often, the best or only way to get a grip on the dentures 100 is to pull with the fingernails on an upper edge 110 of the dentures 100 (the upper edge 110 as depicted or a corresponding lower edge on lower jaw dentures). This can be hard when fingernails are too short or too long. Additionally, many denture wearers also lack physical strength or dexterity in their hands and arms. All of these factors may lead to great difficulty and/or frustration in the removal of dentures 100. Similarly, other anchoring methods may also require an amount of force that may be difficult to overcome by hand.

In the depicted embodiment, the dentures 100 also include a recess 112 which facilitates easy removal of the dentures 100 and which may overcome the above mentioned challenges. The recess 112 is configured to receive a portion of a tool which engages the recess 112. A user or other individual can than apply a force to the tool, and in turn to the dentures 100, to remove the dentures 100. Thus, the recess 112 and an associated tool can be used to obtain a secure grip on the dentures 100 to overcome the connection between the anchor housings 114 and the corresponding dental implants. In other embodiments, the recess 112 may be used to remove a dental prostheses anchored using any method.

The location of the recess 112 is illustrative of one embodiment. In the depicted embodiment, the recess 112 is located on the “gum portion” or base 102 of the dentures 100. This means, for example, that the recess 112 is located above the gum line on upper dentures, such as the dentures 100 of FIG. 1 and below the gum line on lower dentures (not shown). The gum line is the boundary between the teeth 104 and the base 102, which is generally configured to look like the gums of healthy mouth. Location on the gum portion may provide desirable benefits. For example, the recess 112 may be more difficult to see since the gum portion is typically less visible than the teeth 104. This may help obscure the fact that a user is wearing dentures 100. Other embodiments may include a recess 112 placed in other locations such as on a tooth or between teeth 104.

Additionally, the location of the recess 112 on the gum portion may limit the amount of food that comes in contact with the recess 112. This may help to reduce the amount of food caught in the recess 112 or the amount of tartar build up on or in the recess 112. According to the depicted embodiment, the recess 112 is also located below the upper or top edge 110 of the dentures 100. According to a similar embodiment on lower dentures, the recess 112 would be placed above the lower edge. As used herein, a “top edge” may include both the upper edge 110 for an upper denture 100 and the lower edge for a lower denture 100. This may reduce the danger of damage to the real gums of the user's mouth when attempting to apply a removal tool to the recess 112. In one embodiment, the recess 112 is located at a location near the top edge of the dental prosthesis 100 such that the recess 112 fits within the dental prosthesis 100 and a top portion of the recess 112 is adjacent to the top edge. Location of the recess 112 will be discussed further in relation to FIG. 2.

Other embodiments may include one or more recesses 112 in different locations than depicted. For example, the recess 112 may be located at the top of the gum line or could be below the gum line in some embodiments. Additionally, the dentures 100 as shown are exemplary only. The principles and teaching provided above may apply to any type of dental prosthesis including dentures for the lower jaw, partial dentures, bridges, crowns, novelty dentures, or dentures used as part of a costume etc. The recess 112 may be used on implant dental prostheses or dental prostheses mounted in a variety of other manners. Additional description of possible recess 112 and tool embodiments will be provided in relation to the remaining figures.

Turning now to FIG. 2, exemplary configurations of the recess 112 in relation to the teeth 104, the base 102, and the upper edge 110 of the dentures 100 are shown. FIG. 2 depicts exemplary cutaway views 200a-200d taken along the line 116 of FIG. 1. The cutaway views 200a-200d are exemplary only and illustrate possible configurations that may be present in various embodiments.

The cutaway view 200a shows a recess 112 formed in the base 102 of the dentures 100. The recess 112, as depicted in cutaway view 200a, may be formed of the same material as the base 102. The recess 112 includes a tool engaging surface which includes a seat portion (shown within box 202) on the side of the recess 112 closest to the teeth 104 where force may be applied in a direction primarily away from a user's gum to remove the dentures 100. (In the depicted embodiment, the force is applied primarily downward.) As used herein the term seat portion is given to mean the portion of the recess 112 that receives pressure from a removal tool when pressure is applied to the recess 112 in a removal direction.

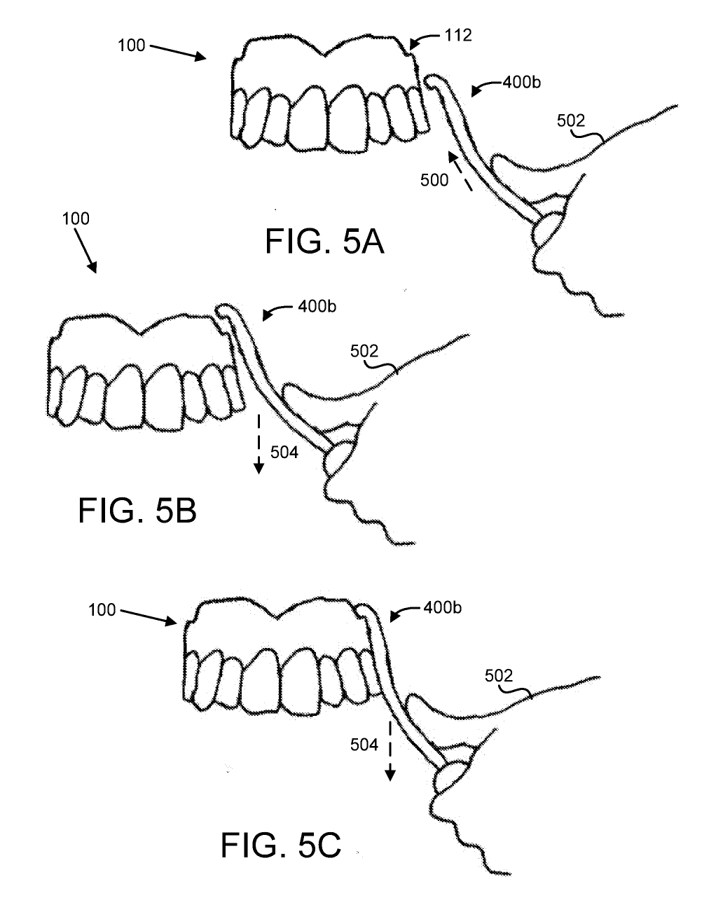

The recess 112 is open from one side and above, as shown. The recess 112 of cutaway view 200a being open from above and a side allows a portion of a removal tool (not shown) to be moved upward past the recess 112 and then downward to engage the seat portion 202 of the recess 112. The recess 112, in this embodiment may be described as a shelf, meaning that the recess 112 protrudes from the base 102 forming somewhat of a shelf. See FIG. 5 for an illustration of engaging the recess 112. This may enable a user to easily locate and engage the recess 112 because the seat portion 202 of the recess 112 protrudes away from the base 102 and will be easily engaged by a tool. In one embodiment, the seat portion 202 is primarily flat and perpendicular to a force applied to remove the dental prosthesis 100. In another embodiment, the seat portion 202 includes a ridge 206 and a lower portion 208; the ridge 206 being adjacent to the exterior of the base 102 and the lower portion 208 adjacent to the ridge 206 and positioned away from the exterior of the base 102 toward an interior of the dental prosthesis 100. In this embodiment, the ridge 206 may allow a removal tool to fit over the ridge 206 and into the lower portion 208 for a more secure connection.

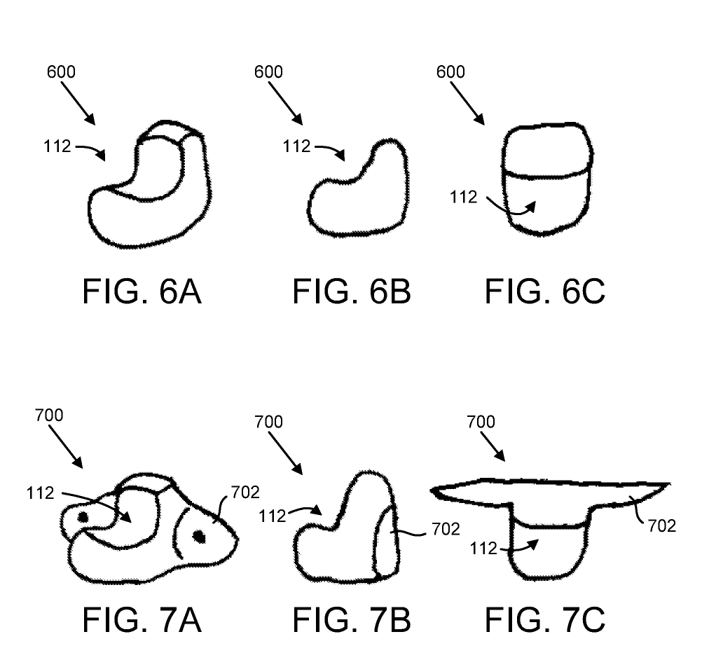

The cutaway view 200b shows a recess 112 having a similar cross-sectional shape as the cutaway view 200a. Once again, the recess 112 is open from one side and above, as shown. However, the recess 112 is formed in a separate recess housing 204 rather than in the base 102. According to one embodiment, the recess housing 204 is separately formed and then included in or on the dentures 100. According to one embodiment, the recess housing 204 is separately manufactured and/or mass produced. This may allow dentists or dental technicians to more easily create tool conforming recesses 112. Separately manufacture recess housings 204 may also be constructed of stronger or harder materials than the base 102 or have other desirable characteristics. Additionally, by forming a recess 112 separately in a recess housing 204 a more precise recess 112 may be created. Exemplary embodiments of separately formed recess housings 204 are depicted in FIGS. 6A-6C and 7A-7C.

The cutaway views 200c and 200d illustrate alternative cross-sectional shapes for the recess 112. Specifically, cutaway views 200c and 200b shows the recess 112 having an upper side forming a pocket, rather than being open above. In cutaway view 200c the upper side slopes gradually into the recess 112 to allow a tool to easily slide into the recess 112 from above, which may be desirable in some embodiments. For example, this shape may allow a user to manipulate a tool to engage the recess 112 in the manner mentioned above and as depicted in FIG. 5.

In cutaway view 200d the upper side is shaped similar to the seat portion 202 of the recess 112. This may allow the use of a tool, once inserted, to apply a force in an upward (or mounting direction) as well as a downward direction (or removal direction). This is different from cutaway views 200a-200c where, due to the shape of a recess 112, it may be difficult or impossible to apply a force in an upward or mounting direction by engaging the recess 112. For example, the recesses 112 of the cutaway views 200a-200c either have no above side or the above side is sloped such that it may be very difficult to apply an upward force. In some embodiments, the ability to apply a force to the recess 112 in an upward, or mounting, direction may not be needed because such a force may be applied to another portion of a dental prosthesis such as the teeth 104 or an exposed portion of the base 102. Additionally, the recess 112 of cutaway view 200d may be more difficult to engage with a tool and may be more prone to trapping food.

In other embodiments, the recess 112 may be shaped to accommodate a tool that may precisely engage the recess 112, or may allow a removal tool (or “tool”) that may snap or lock into the recess 112 and to retain the removal tool when a force is applied to the removal tool in a removal direction below a threshold. The recess 112 may include a retaining ridge to aid in allowing the removal tool to be snapped into the recess 112. The shape depicted in cutaway view 200d may be sized so a tool will snap into place based on the upper and lower ridges 210, 212, or, in another embodiment, just the upper ridge 210 if the seat portion 202 of the recess 112 is more flat. The retaining ridge (e.g. 210, 212) may be positioned perpendicular to a force in the direction to remove the dental prosthesis 100 from the one or more dental studs.

In other embodiments, sides of the recess 112 are used to allow a tool to be snapped into the recess 112. In another embodiment, the recess 112 is round with a lip positioned toward the outside and a tool with a round recess engaging surface snaps into the hole. One of skill in the art will recognize other ways that a tool may snap or lock into a recess 112. The cutaway views 200a-200d are exemplary only. As will be understood by one skilled in the art in light of the present disclosure, many other variations, such as variations on the cross-sectional shapes of the recess 112 may be present in different embodiments.

Note that the examples in FIG. 2 depict only a cross section and a recess 112 may take on many shapes when viewed from a side view. For example, the shape depicted in cutaway view 200a may run horizontally along the base 102 the entire length of the base 102, for a small portion of the base 102, or may be as wide or slightly wider than a tool. The same may be said for the other shapes depicted in FIG. 2. In one embodiment, a recess 112 is as wide or slightly wider than the recess engaging portion of a tool to minimize irritation, food build up, or for aesthetic reasons. In other embodiments, the recess 112 may be wider to allow a wider area to provide force from a tool, to allow easier cleaning, etc. One of skill in the art will recognize other ways to size a recess 112 in a dental prosthesis 100 based on aesthetics and functional requirements.

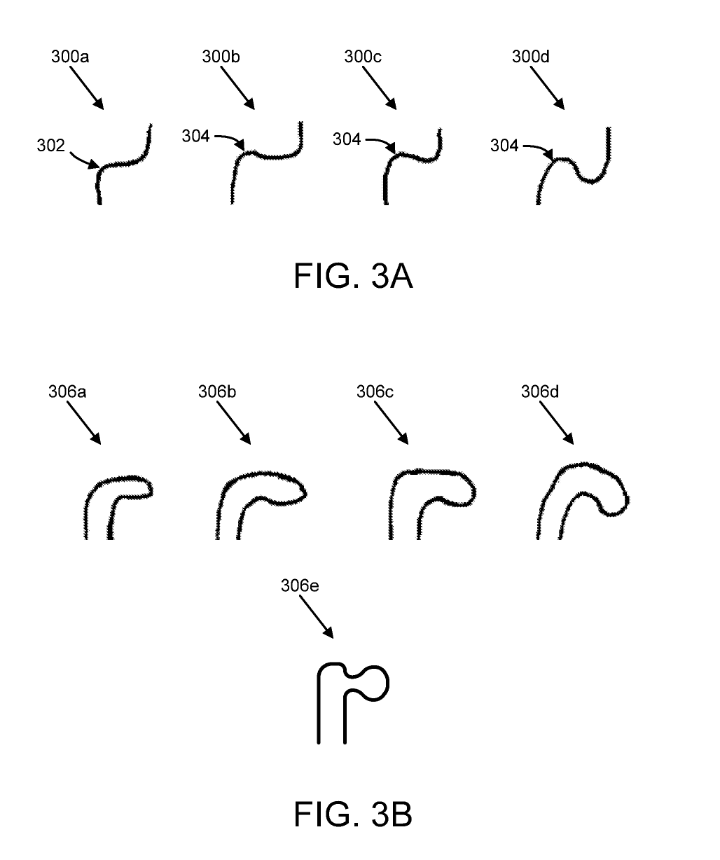

FIG. 3A depicts exemplary seat portions 300a-300d according to varying embodiments from the view of box 202 of FIG. 2. Seat portion 300a includes a mostly flat surface where a removal tool may be placed to engage the recess 112 and apply a force in a downward or removal direction. The flat surface of the seat portion 300a approximately forms a corner 302 with an outside wall at its edge.

Seat portion 300b includes a flat surface as well as a retaining ridge 304 near the edge of the seat portion 300b. The flat surface with the retaining ridge 304 creates a positive rest, or indentation, that helps to maintain a tool on the seat portion 300b when a force is applied in a downward or removal direction. The removal direction is the direction in which the dentures 100 or other dental prosthesis must be moved to remove them from a patient's mouth. This may be a variety of different directions. For example, the upper dentures 100 shown in FIG. 1 may have a downward removal direction while lower dentures may have an upward removal direction.

The seat portions 300c and 300d also create positive rests with retaining ridges 304. As depicted, the sizes of the retaining ridges 304 may be varied to create larger indentations or rests. Larger retaining ridges 304 may be desirable to more securely maintain a removal tool on the seat. Smaller retaining ridges 304 may be desirable to allow a tool to more easily be removed from a seat portion 300a-300d. The shape of the recess 112 may be varied to balance retaining a removal tool, ease of insertion, ease of use, minimizing of food buildup, etc.

FIG. 3B depicts exemplary recess engaging portions 306a-306e according to varying tool embodiments. The recess engaging portions 306a-306d include surfaces that correspond in shape to the seat portions 300a-300d of FIG. 3A. In the depicted embodiments, the shape of the recess engaging portions 306a, 306b, 306c, and 306d each correspond to the seat portions 300a, 300b, 300c, and 300d, respectively. The shape of the recess engaging portion 306e corresponds to the recess 112 shape of cutaway view 200d of FIG. 2. According to one embodiment, the fit between a recess engaging portion 306a-306d and the corresponding seat portion 300a-300d or recess 112 is a precision fit. Increased precision may facilitate engagement of the tool with the recess 112 and may also help maintain the tool within the recess 112 during the removal process.

According to one embodiment, the recess 112, seat portions 300a-300d, and recess engaging portions 306a-306d are formed to have smooth corners, edges, and other features. This may help reduce the likelihood of oral injury or irritation. Other recess engaging portion 306 shapes with square edges, flat surfaces, other curves, etc. are also possible. Recess engaging portion 306e, in one embodiment, is shaped to snap into a shape similar to the one depicted in cutaway view 200d. The recess engaging portion 306e may snap in by engaging a recess 112 along upper and lower ridges 210, 212, or may snap in with contact on the sides, or both. One of skill in the art will recognize other ways for a recess engaging portion 306e to snap into a recess 112.

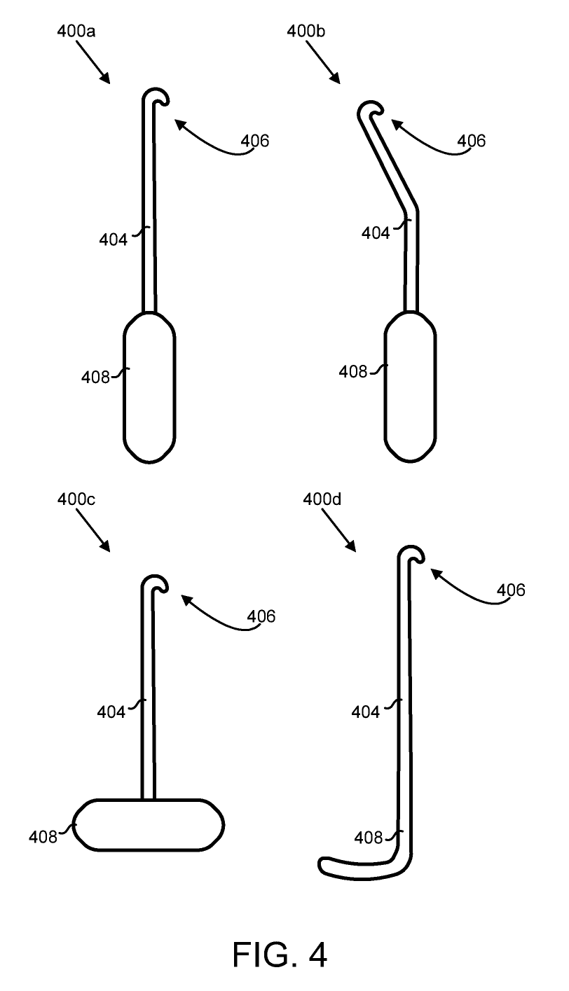

FIG. 4 depicts a number of exemplary tools 400a-400d (collectively “400”), according to varying embodiments. Tool 400a includes a shaft 404 having a recess engaging portion 406 at one end and a handle 408 at the other end. According to one embodiment, the shaft 404 is typically formed of a rigid and strong material such as metal, plastic, etc. and may be made of a combination of materials. The shaft 404 of tool 400a, as depicted, is straight. The recess engaging portion 406 may be any shape or size, such as the recess engaging portions 306a-306e of FIG. 3B, to engage a corresponding seat portion or recess 112. In one embodiment, the recess engaging portion 406 is shaped to closely match the shape of a recess 112. The depicted shape of the recess engaging portion 406 is exemplary only and may be replaced with other shapes, sizes, or configurations. The handle 408 is depicted with a greater diameter than the shaft 404. This may help users to get a better grip on the tool 400a. According to one embodiment, the handle 408 is formed of a soft material which may allow for better gripping properties. According to one embodiment, the handle 408 includes small ridges, or other features, that fit the fingers of a hand to facilitate gripping.

Tool 400b is similar to the tool 400a except that the shaft 404 is bent rather than straight. The bent shaft 404 may allow for easier access to a recess 112 when the dentures 100 are mounted in a user's mouth. For example, the bent shaft 404 may especially be more convenient to access a recess 112 on a lower jaw denture (not shown). Additionally, the bent shaft 404 may also allow a user to apply greater torque, such as with a thumb (see FIG. 5). According to one embodiment, the shaft 404 includes a flattened portion where a thumb may be placed to provide added torque or leverage.

Tool 400c is also similar to tool 400a. However, the shaft 404 is connected along a side of the handle 408 rather along an axis of the handle 408. The configuration of the handle 408 of tool 400c may be more comfortable or easier to use for some users.

Tool 400d includes a shaft 404 and recess engaging portion 406. However the handle 408 is formed of the same material as the shaft 404. The tool 400d may be cheaper and easier to manufacture, in some embodiments. Additionally, the tool 400d may also be smaller and convenient for travel and/or storage.

Additional variations are also possible and may be desirable in other embodiments. For example other embodiments may include different materials or have different shapes or configurations for the handle 408, shaft 404, or recess engaging portion 406. Additionally, some embodiments may include additional features, such as a brush for cleaning the recess 112 and/or dentures 100. For example, a brush may protrude from one end of a handle 408 with the shaft 404 protruding from the other end.

FIGS. 5A-5C depict exemplary usage of a tool 400b to remove dentures 100 having a recess 112. In FIG. 5A the dentures 100, a tool 400b, and a user's hand 502 are shown. The dentures 100 are mounted in a user's mouth, but the user's mouth and head are not shown to maintain clarity and simplicity. The hand 502 is inserting the tool 400b into the user's mouth by moving the end of the tool 400b upward along the side of the dentures 100 in the direction of arrow 500. As depicted, the tool 400b is below the recess 112. By moving the tool 400b along the side of the dentures 100 and upward, the tool 400b may move past the recess 112. Due to the shape of the tool 400b and the recess 112, the tool 400b will be free to move past the recess 112.

FIG. 5B shows the tool 400b after it has been moved vertically past the recess 112. The user may be able to feel the tool 400b pass over the recess 112 and thus know the tool 400b can then be moved downward to engage the recess 112. In FIG. 5B the user moves the tool 400b downwards in the direction of arrow 504. Due to their shape and geometry, as previously discussed, the tool 400b and recess 112 engage. FIG. 5C shows the tool 400b engaged with the recess 112. The user may then apply a force in the direction of arrow 504 to disconnect the dentures 100 from dental implants. A user may use a thumb of the hand 502 to apply a precise amount of pressure and/or torque to remove the dentures 100. According to one embodiment, this may detach the dentures 100 completely from all dental implants, or only a portion of the dental implants. According to one embodiment, the user may repeat the process with one or more additional recesses 112, or repeatedly with the same recesses 112, to remove the dentures 100 from any attached implants.

As will be understood by one of skill in the art in light of the present disclosure, the principles discussed above may be applied to dentures or dental prostheses mounted on the lower jaw with minor variation. For example, dentures mounted on the lower jaw may need to be remove by applying an upward, rather than a downward, force to remove the dentures. Thus, the terms mounting direction and removal direction may refer to different directions depending on the dental prostheses and where it is mounted.

Turning now to FIGS. 6A-6C one embodiment of an exemplary recess housing 600 is shown. FIG. 6A shows a perspective view, FIG. 6B shows a side view, and FIG. 6C shows a top view of the separately formed recess housing 600. The recess housing 600 includes a recess 112 similar to those previously described. The recess housing 600 may be formed of a variety of materials or in a variety of manners. According to one embodiment, the recess housing 600 is formed of metal, plastic, acrylic, zirconia porcelain, etc. In one embodiment, the recess housing 600 is formed of the same material as a corresponding dental prosthesis 100. In other embodiments, the recess 112 may be cast, milled, stamped, etc. In one embodiment, the shape of the recess 112 is formed to correspond to a specific tool, such as tools 400a-400d of FIG. 4. In another embodiment, a dentist or dental technician may include the recess housing 600 within dentures or another dental prosthesis and provide a patient with a corresponding tool 400.

Turning now to FIGS. 7A-7C, another embodiment of a recess housing 600 is shown. FIG. 7A shows a perspective view, FIG. 7B shows a side view, and FIG. 7C shows a top view of the separately formed recess housing 600. The recess housing 700 include a recess 112 similar to that of the recess housing 600 of FIGS. 6A-6C. Additionally, the recess housing 700 includes retention rings 702. The retention rings 702 may be use to attach the recess housing 700 to a side of a dental prosthesis 100. For example, the screws or other attachment mechanisms may be used to fasten the wings 702, and thus the recess housing 700 to a dental prosthesis 100. Additionally or alternatively, the retention rings 702 may be use to more securely embed the recess housing 700 in a dental prostheses. For example, the recess housing 700 may be at least partially embedded in the base 102 of dentures 100 of FIG. 1.

Use of a separately formed recess housing 600, 700 may simplify the creation of a recess 112 in a dental prosthesis 100. For example, it may be difficult to form a recess 112 that precisely fits a tool 400 directly in the dentures 100 at the time of molding the base 102. Or, if forming the recess 112 in the base 102 after molding, there may not be sufficient material. Using separately formed recess housings 600, 700 may overcome these difficulties in some embodiments.

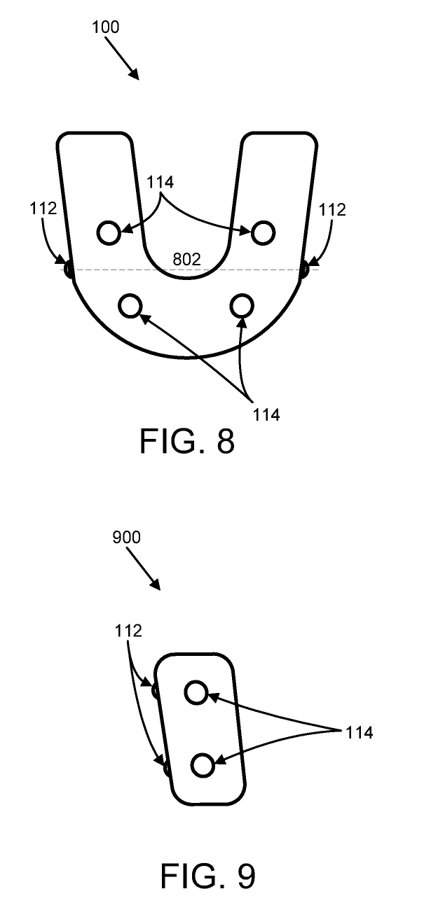

Placement of recesses 112 and/or recess housings 600, 700 will now be discussed in relation to FIGS. 8 and 9. FIG. 8 shows a top plan view of dentures 100, according to one embodiment. In the depicted embodiment, the dentures 100 include four anchor housings 114 which are formed in the dentures 100. The anchor housings 114 are arranged to form an axis of symmetry 802 on which recesses 112 are located. Placing the recesses 112 substantially on an axis of symmetry 802 may allow for easier removal of the dentures 100. For example, applying a force to the recesses 112 located near or on the axis of symmetry 802 may result in an equal or near equal amount of force being applied to the anchor housings 114. This may result in a smoother and quicker removal of the dentures 100. In other embodiments, the recess 112 may be located ahead or behind the axis of symmetry 802. While two recesses 112 are shown, one, two, or more recesses 112 may be included.

FIG. 9 shows a top plan view of partial dentures 900 having two anchor housings 114. Each recess 112, in the depicted embodiment, is placed at a location on a side of the partial dentures 900 that is closest to a respective anchor housing 114. This placement may allow the anchor housings 114 to be removed one at a time. For example, a user may apply a tool 400 to one of the recesses 112 and apply a force to remove one of the anchor housings 114 from a dental stud. Then, the user may apply the tool 400 to the other recess 112 to remove the partial dentures 900 from the other anchor housing 114. In another embodiment, the partial denture 900 may include a single recess 112. In a further embodiment, the single recess 112 may be somewhere between the anchor housings 114, or may be centered between the anchor housings 114.

The above placements of the recesses 112 are exemplary only. One of skill in the art, in light of the present disclosure, may recognize placements that may provide benefit or advantages without departing from the scope of the present disclosure. For example, a recess 112 may be placed approximately halfway between two ends of a dental prosthesis 100. Or, a recess 112 may be placed such that it is approximately equidistant from two or more anchor housings 114.

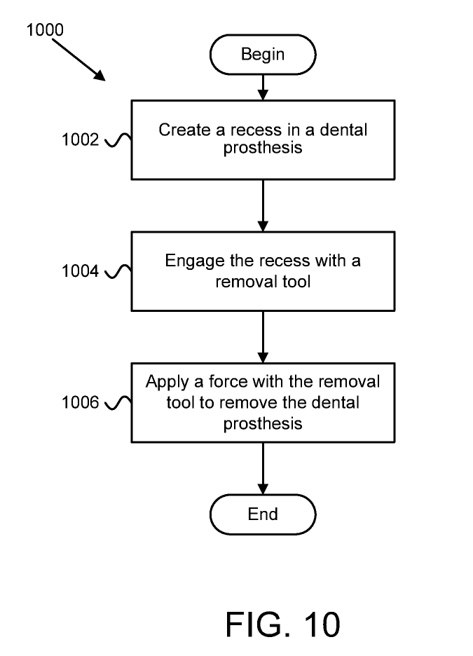

FIG. 10 is a flowchart diagram of one embodiment of a method 1000 for facilitating removal of a dental prosthesis 100. The method 1000 begins and includes creating 1002 a recess 112 on a dental prosthesis 100. The dental prosthesis 100 is mountable on one or more dental studs and the one or more dental studs are each connected to a dental implant in the jaw of a user. The recess 112 includes a tool engaging surface that has a shape corresponding to a recess engaging surface of a removal tool 400.

The method 1000 also includes engaging 1004 the recess engaging surface of the removal tool 400 to the tool engaging surface of the recess 112. The method 1000 includes applying 1006 a force with the recess engaging surface of the removal tool 400 to the tool engaging surface of the recess 112 in a direction to remove the dental prosthesis 100 from the one or more dental studs, and the method 1000 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to facilitate removal of a dental prosthesis, the apparatus comprising:
a recess on a dental prosthesis, the dental prosthesis mountable on one or more dental studs, the one or more dental studs each connected to a dental implant in the jaw of a user, the recess comprising a tool engaging surface, the tool engaging surface having a shape corresponding to a recess engaging surface of a removal tool,
wherein the user may apply the recess engaging surface of the removal tool to the tool engaging surface of the recess and apply a force in a direction to remove the dental prosthesis from the one or more dental studs.

2. The apparatus of claim 1, wherein the tool engaging surface has a shape that closely matches the recess engaging surface of the removal tool.

3. The apparatus of claim 1, wherein the recess comprises an indentation with a shape that is one or more of a shelf and a pocket.

4. The apparatus of claim 1, wherein one of:
the dental prosthesis comprises upper dentures, and the recess is located below an upper edge of the dental prosthesis; and
the dental prosthesis comprises lower dentures, and the recess is located above a lower edge of the dental prosthesis.

5. The apparatus of claim 1, wherein the recess is located on a gum portion of the dental prosthesis.

6. The apparatus of claim 5, wherein the recess is located above a gum line of the dental prosthesis and below a top edge of the dental prosthesis, the top edge distal to false teeth connected to the gum portion.

7. The apparatus of claim 6, wherein the recess is located near the top edge of the gum portion dental prosthesis such that the recess fits within the gum portion and a top portion of the recess is adjacent to the top edge.

8. The apparatus of claim 1, wherein the tool engaging surface of the recess comprises a seat portion, wherein the seat portion includes one of a substantially flat seat portion; and
a ridge above a lower portion, the ridge positioned near the external surface of the dental prosthesis and the lower portion positioned adjacent to the ridge and toward an interior of the dental prosthesis.

9. The apparatus of claim 1, wherein the recess and the dental prosthesis are formed of different materials.

10. The apparatus of claim 9, wherein the dental prosthesis is at least partially formed from a first material and the recess is at least partially formed of a second material, the second material being stronger than the first material.

11. The apparatus of claim 1, wherein the recess is formed of one or more materials from the group consisting of metal, plastic, acrylic, and porcelain.

12. The apparatus of claim 1, wherein the tool engaging surface comprises a retaining ridge, the retaining ridge configured to allow an engaged removal tool to snap into the recess and to retain the removal tool when a force is applied to the removal tool in a removal direction below a threshold.

13. The apparatus of claim 12, wherein the retaining ridge is positioned perpendicular to the force in the direction to remove the dental prosthesis from the one or more dental studs.

14. The apparatus of claim 1, further comprising one or more additional recesses on the dental prosthesis.

15. The apparatus of claim 14, wherein the dental prosthesis comprises one or more anchor housings arranged to connect to the one or more dental studs in the jaw of the user and arranged to form one or more axes of symmetry, and wherein at least one recess is located on the one or more axes of symmetry.

16. The apparatus of claim 1, wherein the recess is located substantially halfway along one of
the length of the dental prosthesis; and
the width of the dental prosthesis.

17. The apparatus of claim 1, wherein each dental stud of the one or more dental studs corresponds to an anchor housing in the dental prosthesis and a specific amount of force is required to dislodge an anchor housing from a dental stud.

18. The apparatus of claim 17, wherein the force to dislodge the anchor housing from the dental stud is in a direction substantially along an axis aligned with the dental implant connected to the dental stud.

19. A system to facilitate removal of a dental prosthesis, the system comprising:
a dental prosthesis mountable on one or more dental studs, the one or more dental studs each connected to a dental implant in the jaw of a user;
a removal tool;
a recess on the dental prosthesis, the recess comprising a tool engaging surface, the tool engaging surface having a shape corresponding to a recess engaging surface of the removal tool,
wherein the user may apply the recess engaging surface of the removal tool to a tool engaging surface of the recess and apply a force in a direction to remove the dental prosthesis from the one or more dental studs.

20. A method for facilitating removal of a dental prosthesis, the method comprising:
creating a recess on a dental prosthesis, the dental prosthesis mountable on one or more dental studs, the one or more dental studs each connected to a dental implant in the jaw of a user, the recess comprising a tool engaging surface, the tool engaging surface having a shape corresponding to a recess engaging surface of a removal tool;
engaging the recess engaging surface of the removal tool to the tool engaging surface of the recess; and
applying a force with the recess engaging surface of the removal tool to the tool engaging surface of the recess in a direction to remove the dental prosthesis from the one or more dental studs.
